(19) United States
(12) Patent Application Publication
(10) Pub. No.: US 2013/0232208 A1
(43) Pub. Date: Sep. 5, 2013

(54) METHOD AND DEVICE FOR UPDATING MESSAGES

(71) Applicant: Ning Lao, Shenzhen (CN)

(72) Inventor: Ning Lao, Shenzhen (CN)

(73) Assignee: TENCENT TECHNOLOGY (SHENZHEN) COMPANY LIMITED, Shenzhen, Guandong (CN)

(21) Appl. No.: 13/819,703

(22) PCT Filed: Jul. 4, 2011
(86) PCT No.: PCT/CN2011/076820

§ 371 Date: May 9, 2013

(30) Foreign Application Priority Data
Aug. 31, 2010 (CN) 201010272335.0

(51) Int. Cl. H04L 12/58

(52) U.S. Cl. CPC H04L 51/04
USPC 709/206

(57) ABSTRACT

The invention discloses a method and a device for updating messages, which belong to the technical field of microblog technology. The method comprises: acquiring message indexes from a microblog server when a user requests updating messages; determining K message indexes as message indexes of the messages for initial message display from the acquired message indexes according to the preset number K, acquiring the corresponding messages from the microblog server according to the message indexes of the messages for initial message display and displaying the corresponding messages to the user; wherein K is a natural number. The device comprises: an acquisition module and an initial display module. The invention reduces the load on the microblog server, avoids resources waste at the client and improves the user's experience.

### BACKGROUND OF THE INVENTION

1. Technical Field

The invention relates to the technical field of microblog technology, in particular to a method and a device for updating messages.

2. Description of Related Art

In a microblog system, when a microblog user sends a message, all other users following this user will be notified of receiving a new message. This means that transmission mode changes from one-to-one relationship as in the traditional IM (Instant Message) application into one-to-more relationship when a microblog server sends messages to microblog clients.

Message notification is very frequent in a microblog system. At present, the method for updating messages in the microblog system is to update and display all new messages at one time. When a microblog client requests new messages from the microblog server, the microblog server will provide all messages updated from the last time to the present time in the microblog system for the microblog client as the new messages so as to complete the update and display of the messages of the microblog client.

There are large amount of messages in the microblog system, so the microblog server needs to send many times to complete the message notification, which increases the workload of the server. Moreover, updating and storing the new messages in the microblog client requires a large amount of storage space, which wastes the resources of the microblog client. Meanwhile, displaying a great amount of messages to the user at one time also brings inconvenience to the user.

### BRIEF SUMMARY OF THE INVENTION

To solve the existing technical problem, the embodiment of the invention provides a method and a device for updating messages. The technical solution is as follows:

One objective of the invention is to provide a method for updating messages. The method comprises:

Acquiring message indexes from a microblog server when a user requests updating new messages:

Determining K message indexes as message indexes of the messages for initial message display from the acquired message indexes according to the preset number K, acquiring the corresponding messages from the microblog server according to the message indexes of the messages for initial message display and displaying the corresponding messages to the user;

wherein K is a natural number.

Another objective of the invention is to provide a device for updating messages. The device comprises:

an acquisition module for acquiring message indexes from a microblog server when a user requests updating messages;

an initial display module for determining K message indexes as message indexes of the messages for initial message display from the acquired message indexes according to the preset number K, acquiring the corresponding messages from the microblog server according to the message indexes of the messages for initial message display and displaying the corresponding messages to the user;

wherein K is a natural number.

In the technical solution provided in the embodiment of the invention, by acquiring message indexes from the microblog server, determining the message indexes for initial message display according to the preset number, acquiring corresponding messages from the microblog server and displaying the messages to the user, the microblog server is not required to send all messages to the local side, so workloads on the microblog are reduced. Furthermore, messages are not updated and stored in local side at one time, so resource waste of the client is avoided. Moreover, the messages are displayed to the user for several times according to the preset number, which also reduces the inconvenience brought to the user and improves user's experience.

### BRIEF DESCRIPTION OF THE SEVERAL VIEWS OF THE DRAWINGS

FIG. 1 is a flowchart of a method for updating messages provided by embodiment 1 of the invention;

FIG. 2 is a flowchart of a method for updating messages provided by embodiment 2 of the invention;

FIG. 3 is a schematic view of the combination of the message indexes and the locally stored message indexes provided by embodiment 2 of the invention;

FIG. 4 is a schematic view of storage blocks and indexes of the storage blocks provided by the embodiment 2 of the invention;

FIG. 5 is a structural view of a device for updating messages provided by embodiment 3 of the invention.

### DETAILED DESCRIPTION OF THE INVENTION

To make the objectives, technical schemes and advantages of the invention clarified, the embodiments of the invention are further described in detail with the reference of the attached drawings.

### Embodiment 1

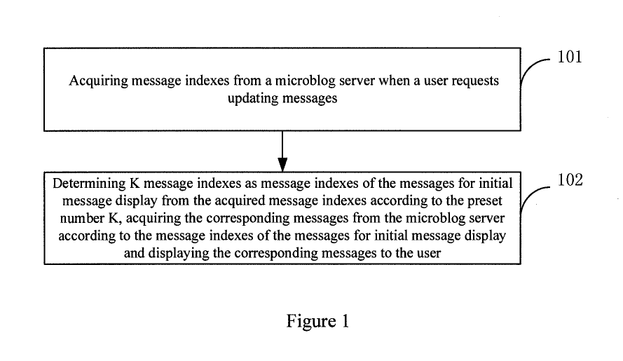

As shown in FIG. 1, this embodiment provides a method for updating messages. The method comprises:

101: Acquiring message indexes from a microblog server when a user requests updating messages;

102: Determining K message indexes as message indexes of the messages for initial message display from the acquired message indexes according to the preset number K, acquiring the corresponding messages from the microblog server according to the message indexes of the messages for initial message display and displaying the corresponding messages to the user; wherein K is a natural number.

In this embodiment, after step 102, the method further comprises:

determining the message indexes except the message indexes of messages for initial display in the acquired message indexes as the message indexes of messages for subsequent message display if the user requests continuous updates; acquiring the corresponding messages from the microblog server according to message indexes for subsequent message display, and displaying the corresponding messages to the user.

The step of acquiring the corresponding messages from the microblog server according to message indexes for subsequent message display, and displaying the corresponding messages to the user specifically comprises:

For each time when the user requests continuous updates, acquiring K message indexes as the current message indexes from the message indexes for subsequent message display, determining the message indexes for subsequent message display as current message indexes if the number of the message indexes for subsequent message display is smaller than K; acquiring the corresponding messages from the microblog server according to the current message indexes, and displaying the corresponding messages to the user.

The method provided by this embodiment is carried out by the microblog client. The user requests the microblog server for updating messages via the microblog client, and the microblog server updates the new messages to the microblog client via the indexes.

In this embodiment, the preset number refers to the default number of the new messages displayed by the microblog client at one time. Usually, the number is preset in microblog client, such as 20 or 30, which is not limited in this embodiment. Usually, a large number of message indexes are acquired from the microblog server, such as 100, 200, etc. The message indexes are divided into two parts, one for initial message display, and the other for subsequent message display. Provided that the microblog client can display 30 messages at one time and 200 message indexes are acquired from the microblog server, the former 30 are used for initial message display, and the rest are used for subsequent message display; and if the user requests continuous updates, then the subsequent messages are continuously displayed.

According to the method provided in this embodiment, by acquiring message indexes from the microblog server, determining the message indexes for initial message display according to the preset number, acquiring corresponding messages from the microblog server and displaying the messages to the user, the microblog server is not required to send all messages to the local side, so workloads on the microblog are reduced. Furthermore, messages are not update and stored in local side at one time, so resource waste of the client is avoided. Moreover, the messages are displayed to the user for several times according to the preset number, which also reduces the inconveniences brought to the user and improves user's experience.

### Embodiment 2

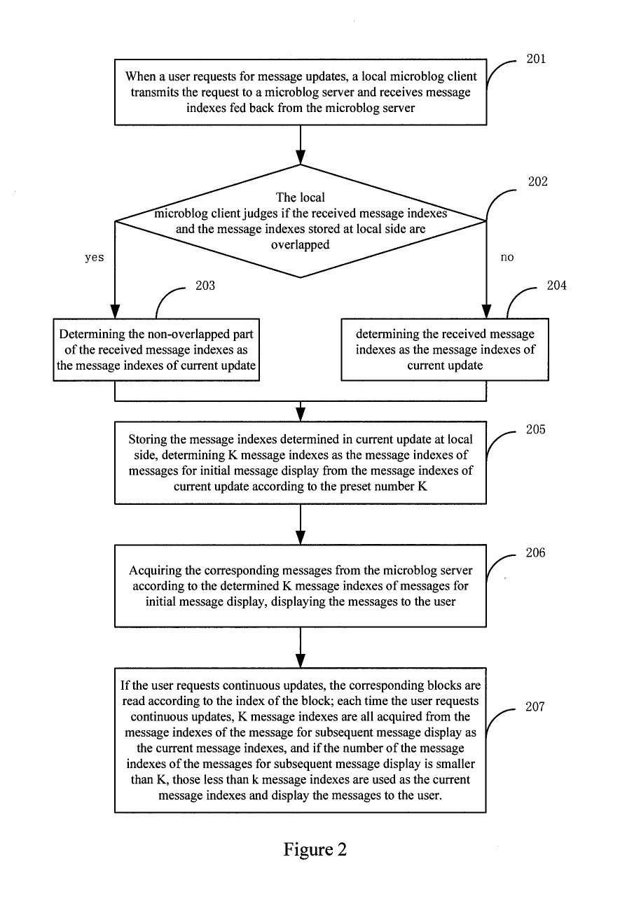

As shown in FIG. 2, this embodiment provides a method for updating messages. The method comprises:

201: When a user requests for message updates, a local microblog client transmits the request to a microblog server and receives message indexes fed back from the microblog server, wherein the message indexes received by the microblog client are indexes of all new messages stored in the microblog server form the last time the microblog client is updated till the current time.

For example, if a microblog client updates the microblog messages at 9:00 at the last time and requests for update at 10:00 currently, then the microblog server sends the message indexes of all new messages between 9:00 and 10:00 to the microblog client. All the new messages may be issued by one microblog client, but usually by different microblog clients, which is not limited in this embodiment.

Messages involved in this embodiment all refer to those issued in the microblog system, and the message indexes refer to index numbers identifying the messages, such as ID numbers.

202: The local microblog client judges if the received message indexes and the message indexes stored at local side are overlapped; and if so, go to 203; otherwise, go to 204.

In this embodiment, there are many ways for the local microblog client to store the message indexes, including but not limited to the form of index list. The message indexes stored at local side are usually located in a fixed storage zone, and the currently received message indexes are usually stored in the cache; overlap refers to identical message indexes. For example, 100 message indexes are stored at local side, the index number of one of the message indexes is 50; 70 message indexes are currently received, and the index number of one of the message indexes is 50; and thus, the two can be judged to be overlapped.

203: Determining the non-overlapped part of the received message indexes as the message indexes of current update and then go to 205.

For example, among 70 currently received message indexes, 20 message indexes are overlapped with those stored at local side, and then the remaining 50 are used as the message indexes of current update, while the overlapped part is not required to be updated.

204: Since there is no overlap between the received message indexes and the message indexes stored at local side, all the message indexes received need to be updated, so determining the received message indexes as the message indexes of current update and then go to 205.

205: Storing the message indexes determined in current update at local side, determining K message indexes as the message indexes of messages for initial message display from the message indexes of current update according to the preset number K, wherein K is a natural number.

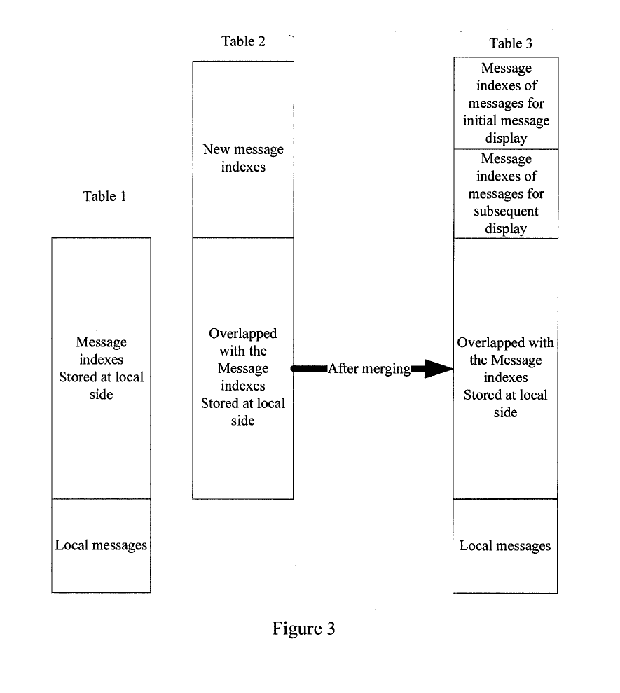

Specifically, after the current update of the message indexes, the message indexes stored at local side have been changed, including the original message indexes before the current update and the message indexes stored in the current update. For example, as shown in FIG. 3, the message indexes stored at local side can be seen in table 1; the temporarily cached received message indexes can be seen in table 2, in which one part is overlapped with the message indexes stored at local side, and the other part is the non-overlapped part, i.e. the new message indexes; table 3 is a new table stored at local side acquired after the message indexes of the current update are determined, which is the combination result of table 1 and table 2, wherein the overlapped part is unchanged, the content of table 3 is equivalent to new message indexes plus the content of table 1, and the new message indexes are divided into two parts: message indexes of messages for initial message display and message indexes of messages for subsequent message display.

The step of combining the chain table of the message indexes stored at local side and the chain table of the temporarily cached received message indexes can be realized by the Merge method. According to this Merge method, the chain table of the message indexes store at local side and the cache chain table are combined by deleting and increasing the indexes to obtain a new chain table of message indexes, and the chain table is enabled to represent the latest message situation of the server.

In this embodiment, the message indexes determined in current update can be stored at local side by many ways, which are not limited here. Preferably, the form of chain table can be adopted, and maintenance is carried out using a block as the unit. The details are as follows:

Record the message indexes determined in current update into blocks and set the indexes of the blocks; store the blocks and the indexes of the blocks at local side. The microblog client updates messages frequently, so more blocks are stored after several updates; one block is stored after each update, each block corresponding to an index of a block; when the messages are required from the microblog server, the corresponding block shall be found via the index of the block, and then the corresponding messages are acquired for update from the microblog server according to the message indexes in the block.

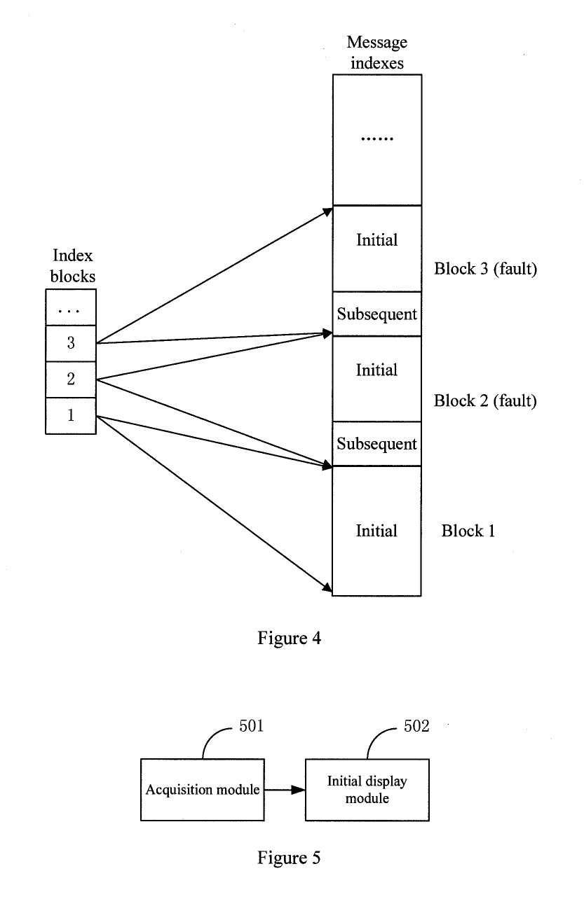

For example, as shown in FIG. 4, the message indexes are stored in the chain table; the message index of each update corresponds to one block in the chain table. Taking three blocks in the figure as an example, the three blocks 1, 2 and 3 are located from the bottom up, and the indexes 1, 2, 3 of the three blocks are correspondingly stored from the bottom up in the block index chain table on the left side of the figure. In the message index chain table on the right side of the figure, some blocks only include the message indexes of messages for initial message display, such as block 1; some blocks include the message indexes of messages for initial message display and the messages indexes of messages for subsequent message display, which are called fault situations in this embodiment, such as block 2 and block 3. The fault refers to that the message update is not completed at one time, but several times according to the request of the user. After the initial default display is completed, if the user requests continuous updates, the messages are continuously acquired according to subsequent message indexes; in accordance with the preset number K, each time the user requests continuous updates, then K messages are acquired from the microblog server to complete update gradually until all messages are acquired or the user stops requesting continuous updates.

206: Acquiring the corresponding messages from the microblog server according to the determined K message indexes of messages for initial message display, displaying the messages to the user, wherein the subsequent message is not acquired at the moment the initial display is completed, so only the message indexes of the subsequent messages are stored at the microblog client, which greatly saves the storage space of the microblog client and avoids resource waste.

207: After the initial display is completed, the user can browse the K messages; if the user requests continuous updates and when the message indexes determined in current update are maintained in the unit of block, the corresponding blocks are read according to the index of the block stored currently, and the message indexes except the K message indexes of the message displayed initially in the block are used as message indexes for subsequent message display; when the message indexes determined in current update are maintained in other forms, it is not required to search for the block, the message indexes except the K message indexes of the message displayed initially are directly used for subsequent message display; each time the user requests continuous updates, K message indexes are all acquired from the message indexes of the message for subsequent message display as the current message indexes, and if the number of the message indexes of the messages for subsequent message display is smaller than K, those less than k message indexes are used as the current message indexes; the corresponding messages are acquired from the microblog server according to the current message indexes and displayed to the user.

During this process, K messages are acquired and displayed at local side, except for the last time in which the number of the messages for display is smaller than K. For example, if the number of the message indexes received by the microblog server is 70 and K=30, then 30 messages are displayed initially; if the user clicks to request for continuous updates, another 30 messages are displayed; if the user clicks to request continuous updates again, the messages corresponding to the last 10 indexes are displayed to the user. This process displays three times, and the number of the messages displayed at the last time is smaller than K. If the former two displays are completed and the user stops sending requests, then the last 10 messages are not displayed.

In the embodiment of the invention, the microblog client may receive the message indexes sent from the microblog server for one or more times. According to the communication protocol, the microblog server shall send the message indexes to the microblog client several times if there are too many message indexes, which is prior art and is not limited in this embodiment. For example, if the microblog server requires to send 200 message indexes, while only 70 message indexes are allowed to be sent each time according to the communication protocol, then the microblog server will send the message indexes three times, 70 for the first two times and 60 at the last time.

According to the method provided by the embodiment, the microblog server sends the message indexes to the microblog server first, and then the microblog client acquires corresponding messages from the microblog server according to the message indexes of messages for initial message display and the message indexes of messages for subsequent message display respectively, so the microblog server is not required to send all messages to the microblog client at one time, which reduces the load on the microblog server. Furthermore, the microblog client does not update all messages or store the messages at the local side at one time; the subsequent messages are updated after the user requests continuous updates; and if the user does not request continuous updates, the subsequent message is not updated, which avoids resources waste at the client side. Moreover, the messages are displayed to the user for several times according to a preset number, which also reduces inconveniences brought to the user and improves the user's experience.

### Embodiment 3

As shown in FIG. 5, this embodiment provides a device for updating messages. The device comprises:

an acquisition module 501 for acquiring message indexes from a microblog server when a user requests updating messages.

an initial display module 502 for determining K message indexes as message indexes of the messages for initial message display from the acquired message indexes according to the preset number k, acquiring the corresponding messages from the microblog server according to the message indexes of the messages for initial message display and displaying the corresponding messages to the user, wherein K is a natural number.

In this embodiment, the device further comprises:

a first subsequent display module for determining the message indexes except the message indexes of messages for initial display in the acquired message indexes as the message indexes of messages for subsequent message display if the user requests continuous updates; acquiring the corresponding messages from the microblog server according to message indexes for subsequent message display, and displaying the corresponding messages to the user.

When the first subsequent display module used for acquiring the corresponding messages from the microblog server according to message indexes for subsequent message display, and displaying the corresponding messages to the user, it is used for:

For each time when the user requests continuous updates, acquiring K message indexes as the current message indexes from the message indexes for subsequent message display, determining the message indexes for subsequent message display as current message indexes if the number of the message indexes for subsequent message display is smaller than K; acquiring the corresponding messages from the microblog server according to the current message indexes, and displaying the corresponding messages to the user.

In this embodiment, the initial display module 502 may comprises:

a judging unit for judging if the acquired message indexes and the message indexes stored at local side are overlapped;

a processing unit for taking the non-overlapped part of the acquired message indexes as the message indexes of current update in the case of overlapped; and taking the acquired message indexes as the message indexes of current update in the case of non-overlapped;

a determining unit for storing the message indexes of current update at local side, and determining K message indexes as message indexes of messages for initial message display from the message indexes of current update according to the preset number K.

Furthermore, the determining unit also may comprise:

a setting subunit for recording the message indexes of current update in a block and setting an index for the block;

a storage subunit for storing the block and index of the block at local side.

In this embodiment, the device may further comprise:

a second subsequent display module for reading the block according to the index of the block if the user requests continuous updates; determining the message indexes except the message indexes of messages for initial display in the block as the message indexes of messages for subsequent message display; for each time when the user requests continuous updates, acquiring K message indexes as the current message indexes from the message indexes of messages for subsequent message display, determining the message indexes of messages for subsequent message display as current message indexes if the number of the message indexes of messages for subsequent message display is smaller than K; acquiring the corresponding messages from the microblog server according to the current message indexes, and displaying the corresponding messages to the user.

In this embodiment, the message indexes acquired by the acquisition module 501 are indexes of all the new messages stored in the microblog server from the last time the local side is updated till the current time.

The device provided in this embodiment may be the microblog client which can implement any one scheme mentioned in the embodiment, and the details can be seen in the embodiment providing the method and are therefore omitted here.

According to the device provided in this embodiment, by acquiring the message indexes from the microblog server and respectively acquiring corresponding messages according to the message indexes for initial message display and the message indexes for subsequent message display, the microblog server is not required to send all messages to the local side, so workloads on the microblog server are reduced. Furthermore, messages are not updated and stored in local side at one time; if the user requests continuous updates, the subsequent messages are updated; and if the user does not request continuous updates, the subsequent message is not updated, which avoids resources waste at the client side. Moreover, the messages are displayed to the user for several times according to the preset number, which also reduces inconveniences brought to the user and improves the experience of the user.

Finally, it should be explained that: those skilled in this field shall understand that all or part of the steps of the method in the above embodiments is completed according to the related instructions given by a computer program which can be stored in an accessible storage medium; the program can implement the steps of the methods mentioned in the embodiments, wherein the storage medium may be a magnetic disc, optical disc, read only memory or random access memory.

The functional units in the embodiment of the invention can be all integrated into one processing module or located individually; two or more functional units can be integrated into one module. The integrated module may be realized in the format of hardware or software functional module. In the case of being realized in the software functional module and sold or used as an individual product, the integrated module can be stored in the readable memory medium of a computer. The above memory medium may be a read-only memory, disk or optical disk, etc. All above devices or systems are capable of executing the method in the corresponding embodiments.

The above descriptions are preferable embodiments of this invention which do not limit this invention. Within the spirit and principle of this invention, any modifications, equivalent substitutions or improvements all shall be included in the protection scope of this invention.

1. A method for updating messages, characterized in that said method comprises:
acquiring message indexes from a microblog server when a user requests updating messages;
determining K message indexes as message indexes of the messages for initial message display from the acquired message indexes according to the preset number K, acquiring the corresponding messages from the microblog server according to the message indexes of the messages for initial message display and displaying the corresponding messages to the user;
wherein K is a natural number.

2. The method according to claim 1, characterized in that after the step of acquiring the corresponding messages from the microblog server according to the message indexes of the messages for initial message display and displaying the corresponding messages to the user, the method further comprises:
determining the message indexes except the message indexes of messages for initial display in the acquired message indexes as the message indexes of messages for subsequent message display if the user requests continuous updates; acquiring the corresponding messages from the microblog server according to message indexes for subsequent message display, and displaying the corresponding messages to the user.

3. The method according to claim 2, characterized in that the step of acquiring the corresponding messages from the microblog server according to message indexes for subsequent message display, and displaying the corresponding messages to the user comprises:
for each time when the user requests continuous updates, acquiring K message indexes as the current message indexes from the message indexes for subsequent message display, determining the message indexes for subsequent message display as current message indexes if the number of the message indexes for subsequent message display is smaller than K; acquiring the corresponding messages from the microblog server according to the current message indexes, and displaying the corresponding messages to the user.

4. The method according to claim 1, characterized in that the step of determining K message indexes as message indexes of the messages for initial message display from the acquired message indexes according to the preset number K comprises:
judging if the acquired message indexes and the message indexes stored at local side are overlapped;
if so, taking the non-overlapped part of the acquired message indexes as the message indexes of current update;
if not, taking the acquired message indexes as the message indexes of current update;
storing the message indexes of current update at local side, and determining K message indexes as message indexes of messages for initial message display form the message indexes of current update according to the preset number K.

5. The method according to claim 4, characterized in that the step of storing the message indexes of current update at local side comprises:
recording the message indexes of current update in a block and setting an index for the block;
storing the block and index of the block at local side.

6. The method according to claim 5, characterized in that after the step of acquiring the corresponding messages from the microblog server according to the message indexes of the messages for initial message display and displaying the corresponding messages to the user, the method also comprises:
reading the block according to the index of the block if the user requests continuous updates; determining the message indexes except the message indexes of messages for initial display in the block as the message indexes of messages for subsequent message display; for each time when the user requests continuous updates, acquiring K message indexes as the current message indexes from the message indexes of messages for subsequent message display, determining the message indexes of messages for subsequent message display as current message indexes if the number of the message indexes of messages for subsequent message display is smaller than K; acquiring the corresponding messages from the microblog server according to the current message indexes, and displaying the corresponding messages to the user.

7. The method according to claim 1, characterized in that the acquired message indexes are indexes of all the new messages stored in the microblog server from the last time the local side is updated till the current time.

8. A device for updating messages, characterized in that said device comprises:
an acquisition module for acquiring message indexes from a microblog server when a user requests updating messages;
an initial display module for determining K message indexes as message indexes of the messages for initial message display from the acquired message indexes according to the preset number K, acquiring the corresponding messages from the microblog server according to the message indexes of the messages for initial message display and displaying the corresponding messages to the user;
wherein K is a natural number.

9. The device according to claim 8, characterized in that said device further comprises:
a first subsequent display module for determining the message indexes except the message indexes of messages for initial display in the acquired message indexes as the message indexes of messages for subsequent message display if the user requests continuous updates; acquiring the corresponding messages from the microblog server according to the message indexes for subsequent message display, and displaying the corresponding messages to the user.

10. The method according to claim 9, characterized in that when the first subsequent display module used for acquiring the corresponding messages from the microblog server according to messages indexes for subsequent message display, and displaying the corresponding messages to the user, it is used for:
for each time when the user requests continuous updates, acquiring K message indexes as the current message indexes from the message indexes for subsequent message display, determining the message indexes for subsequent message display as current message indexes if the number of the message indexes for subsequent message display is smaller than K; acquiring the corresponding messages from the microblog server according to the current message indexes, and displaying the corresponding messages to the user.

11. The device according to claim 8, characterized in that said initial display module comprises:
a judging unit for judging if the acquired message indexes and the message indexes stored at local side are overlapped;
a processing unit for taking the non-overlapped part of the acquired message indexes as the message indexes of current update in the case of overlapped; and taking the acquired message indexes as the message indexes of current update in the case of non-overlapped;
a determining unit for storing the message indexes of current update at local side, and determining K message indexes as message indexes of messages for initial message display form the message indexes of current update according to the preset number K.

12. The device according to claim 11, characterized in that said determining unit comprises:
a setting subunit for recording the message indexes of current update in a block and setting an index for the block;
a storage subunit for storing the block and index of the block at local side.

13. The device according to claim 12, characterized in that said device further comprises:
a second subsequent display module for reading the block according to the index of the block if the user requests continuous updates; determining the message indexes except the message indexes of messages for initial display in the block as the message indexes of messages for subsequent message display; for each time when the user requests continuous updates, acquiring K message indexes as the current message indexes from the message indexes of messages for subsequent message display, determining the message indexes of messages for subsequent message display as current message indexes if the number of the message indexes of messages for subsequent message display is smaller than K; acquiring the corresponding messages from the microblog server according to the current message indexes, and displaying the corresponding messages to the user.

14. The device according to claim 8, characterized in that the message indexes acquired by the acquisition module are indexes of all the new messages stored in the microblog server from the last time the local side is updated till the current time.

15. A computer program product comprising a computer useable medium having computer readable program code functions embedded in said medium for updating messages, the computer program product comprising:
A first computer readable program code function that for acquiring message indexes from a microblog server when a user requests updating messages;
A second computer readable program code function that for determining K message indexes as message indexes of the messages for initial message display from the acquired message indexes according to the preset number K, acquiring the corresponding messages from the microblog server according to the message indexes of the messages for initial message display and displaying the corresponding messages to the user; wherein K is a natural number.
